(19) United States
(12) Patent Application Publication
(10) Pub. No.: US 2025/0076557 A1
(43) Pub. Date: Mar. 6, 2025

(54) DISPLAY SYSTEMS INCLUDING PHOTONIC INTEGRATED CIRCUITS

(71) Applicant: Meta Platforms Technologies, LLC, Menlo Park, CA (US)

(72) Inventors: Guohua Wei, Redmond, WA (US); Zhujun Shi, Redmond, WA (US); Min Chul Shin, Bellevue, WA (US); Risheng Cheng, Redmond, WA (US); Giuseppe Calafiore, Woodinville, WA (US)

(21) Appl. No.: 18/401,296

(22) Filed: Dec. 29, 2023

Related U.S. Application Data
(60) Provisional application No. 63/580,755, filed on Sep. 6, 2023.

(51) Int. Cl. F21V 8/00

(52) U.S. Cl. CPC G02B 6/001

(57) ABSTRACT

A display system may include a display element having an array of pixels, at least one light source, and a photonic integrated circuit (PIC) illumination element overlapping the display element. The PIC illumination element may include at least one in-coupler for in-coupling light from the at least one light source and an array of out-coupling emitters configured to emit light from the PIC illumination element toward the display element. The array of out-coupling emitters may not be aligned pixel-by-pixel with the array of pixels. Various other devices, systems, and methods are also disclosed.

### CROSS-REFERENCE TO RELATED APPLICATIONS

This application claims the benefit of and priority to U.S. Provisional Patent Application No. 63/580,755, filed 6 Sep. 2023, and titled DISPLAY SYSTEMS INCLUDING PHOTONIC INTEGRATED CIRCUITS, the disclosure of which is incorporated, in its entirety, by this reference.

### BRIEF DESCRIPTION OF THE DRAWINGS

The accompanying drawings illustrate a number of example embodiments and are a part of the specification. Together with the following description, these drawings demonstrate and explain various principles of the present disclosure.

FIG. 1 is a cross-sectional view of an example waveguide according to some embodiments.

FIG. 2 is an illustration a portion of an example photonic integrated circuit (PIC) illumination element that includes waveguides defining out-coupler gratings according to some embodiments.

FIG. 3 is a cross-sectional view of an example waveguide according to some embodiments.

FIG. 4 is an illustration a portion of an example PIC illumination element that includes a waveguide and a grating layer defining out-coupler gratings according to some embodiments.

FIG. 5 is an illustration of an example reflective-type display system that includes a liquid crystal on silicon (LCoS) display element and a PIC illumination element according to some embodiments.

FIG. 6 is an illustration of an example transmissive-type display system that includes a liquid crystal display element and a PIC illumination element according to some embodiments.

FIG. 7 is an illustration of a display system that includes a display element and a PIC illumination element having a dispatch circuit according to some embodiments.

FIG. 8 is a flow diagram of an example method for manufacturing a display system that includes a display element and a PIC illumination element according to some embodiments.

FIG. 9 is an illustration of example augmented-reality glasses that may be used in connection with embodiments of this disclosure.

FIG. 10 is an illustration of an example virtual-reality headset that may be used in connection with embodiments of this disclosure.

Throughout the drawings, identical reference characters and descriptions indicate similar, but not necessarily identical, elements. While the example embodiments described herein are susceptible to various modifications and alternative forms, specific embodiments have been shown by way of example in the drawings and will be described in detail herein. However, the example embodiments described herein are not intended to be limited to the particular forms disclosed. Rather, the present disclosure covers all modifications, equivalents, and alternatives falling within this disclosure.

### DETAILED DESCRIPTION OF EXAMPLE EMBODIMENTS

Conventional display illumination is typically based on light-emitting diode (LED) light sources, which have broad spectrum and wide emission angles. These properties of LED light sources commonly lead to low illumination efficiency and low brightness when utilized in display systems with limited power budgets, such as augmented reality head-mounted displays. LEDs also have a smaller color gamut for display applications compared to laser-based displays, resulting in less color space. Additionally, LED broadband sources may not be a good fit for diffractive type displays, such as displays having diffractive optical elements, due to the strong dispersion effect. Conventional laser displays may have advantages of higher brightness, better color gamut, and compatibility with compact lightweight diffractive optical elements. However, conventional types of laser illumination (e.g., laser beam scanning) for displays may have large footprints and may not be suitable for reflective-type displays, such as liquid crystal on silicon (LCoS) displays, and/or transmissive-type displays, such as liquid crystal displays (LCD). Smaller laser illumination systems, on the other hand, may not be efficient enough or may not provide sufficient illumination to display pixel alignment, limiting the smallest display pixel pitch that can be supported. Existing laser displays are typically scanning-based, such that a single collimated laser beam is scanned sequentially to paint an image. However, laser beam scanning displays typically have limited resolution, limited exit pupil size, as well as complicated driving and graphic rendering. It is therefore desirable to have a compact and efficient non-scanning laser display.

The present disclosure is generally directed to display systems that include laser-based illumination elements utilizing photonic integrated circuit (PIC) illumination arrays. According to some embodiments, the display systems may include one or more light sources, such as lasers (e.g., Red, Green, and Blue (RGB) color for typical display applications), that are integrated with a PIC illumination device, which distributes the laser light to a display panel via an array of out-coupling emitters. According to some embodiments, the array of out-coupling emitters of the PIC may not be aligned with an array of display pixels of the display panel. In some examples, the out-coupling emitters can be arranged in a regular array with a fixed pitch in horizontal and vertical directions. In additional examples, the out-coupling emitters can be randomly or semi-randomly arrayed in one or more directions. The spacing or pitch between nearest out-coupling emitters can be larger than the display panel pixel pitch. The disclosed PIC illumination elements may be utilized with reflective-type displays, such as LCoS displays, or transmissive-type displays, such as LCDs. For LCoS systems, the PIC illumination elements may provide front-side illumination. For transmissive LCD systems, the PIC illumination elements may provide backlight illumination.

The disclosed PIC illumination elements may provide various advantages over conventional illumination systems, including the following.

Versatility: The PIC illumination elements may provide laser illumination for a variety of displays, including both transmissive LCD and/or reflective LCoS displays.

Diffractive type display optics: The PIC illumination elements can be used for various augmented reality displays, including both AR and VR display applications, such as holographic displays based on diffractive optical elements.

Compactness: In the PIC illumination elements, a single thin glass layer, which can be as thin as 50 um, may be utilized for illumination and can be built into other existing glass layers in the display stack. Additionally, high index contrast photonic waveguides may allow for the use of compact photonic circuits, providing minimized footprints.

Efficiency: The PIC illumination elements may have intrinsically polarized light sources (i.e., laser diodes) and PIC outputs that couple efficiently with liquid crystal (LC) displays requiring polarized light. Moreover, the intrinsically small etendue of the PIC illumination elements may allow efficient light collection through the optics.

Device integration: No pixel level alignment may be required with the flood illumination provided by the PIC illumination elements, making it easy to integrate with a variety of displays, including displays with relatively small pixel pitches.

Contrast: The PIC illumination elements may provide high contrast due to the ability to emit well controlled illumination with suppressed stray light scattering.

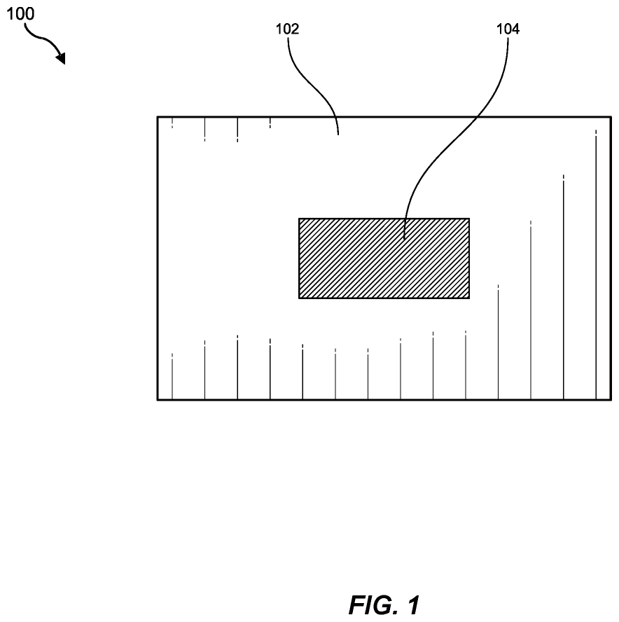

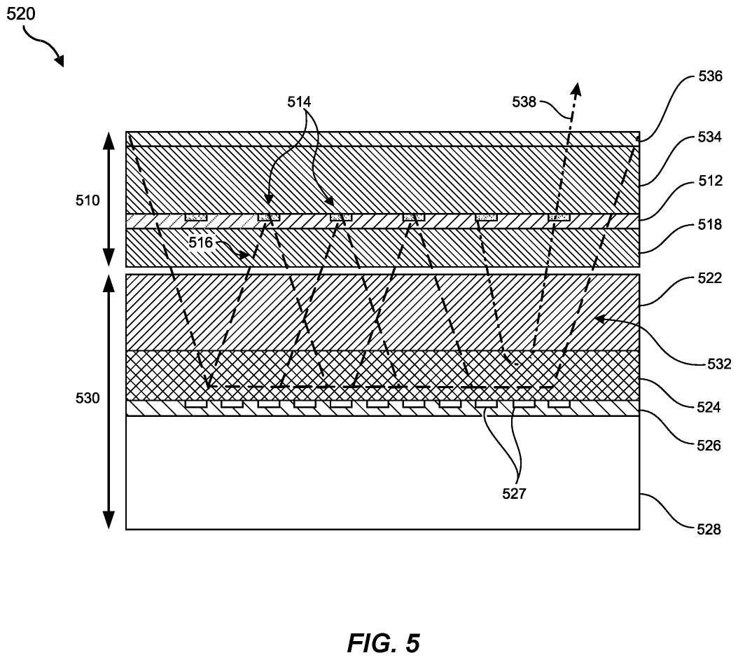

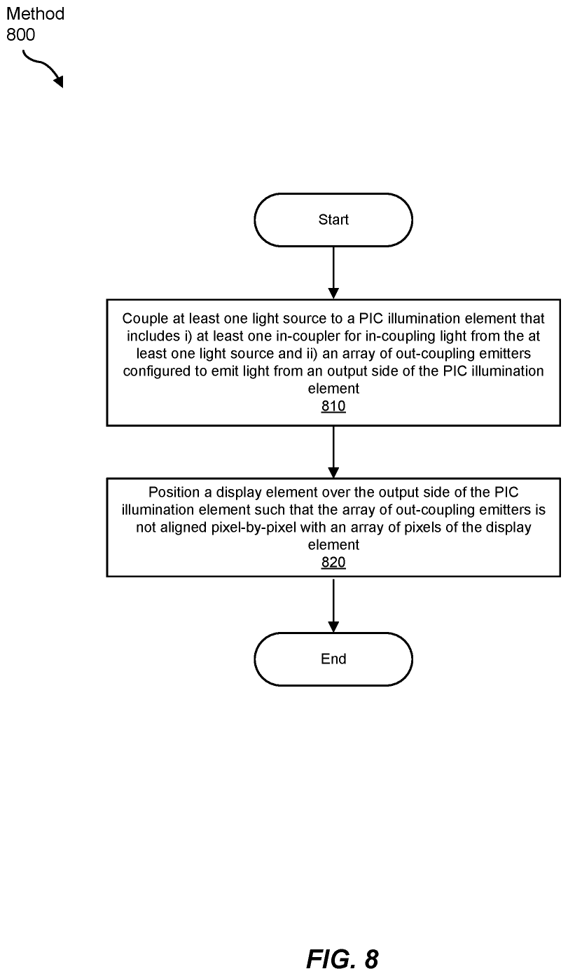

The following will provide, with reference to FIGS. 1-8, a detailed description of display systems that include PIC illumination elements, in accordance with some embodiments. The discussion associated with FIGS. 1-4 relates to PIC illumination elements and components included in such PIC illumination elements. The discussion associated with FIGS. 5-7 relates to display systems that include PIC illumination elements in combination with reflective-type and transmissive-type display elements. Additionally, the discussion associated with FIG. 8 relates to methods for manufacturing display systems that include a display element and a PIC illumination element.

FIG. 1 illustrates a cross-sectional view of a waveguide 100 utilized in display devices and systems described herein, in accordance with some embodiments. According to various embodiments, the PIC illumination systems described herein may include PICs that include waveguides that are based on dielectric layers. As illustrated in FIG. 1, a dielectric layer that is transparent to working wavelengths of light (e.g., silicon nitride, etc.) may be used as a core 102 of waveguide 100 and another dielectric layer with a lower refractive index (e.g., silicon oxide, etc.) may be used as a cladding 104 surrounding core 102. In various embodiments, waveguide 100 may be a single mode waveguide in which a single transverse electric (TE) mode is used that has a polarization parallel to an illumination plane. For such single mode waveguides, their dimensions (e.g., width and/or height) may be close to the wavelengths of light. In some examples, waveguide 100 may be a multiple mode waveguide in which higher order modes are allowed. In at least one example, waveguide 100 may use a transverse magnetic (TM) mode.

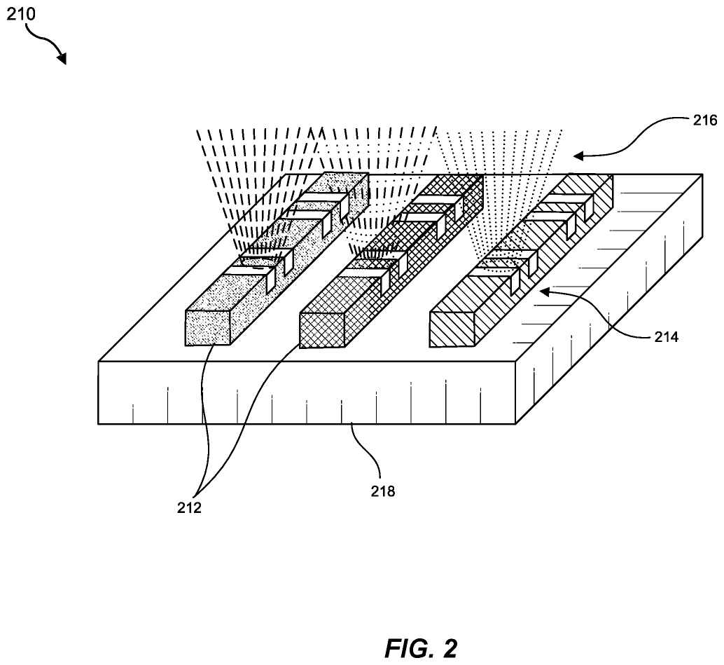

FIG. 2 illustrates a perspective view of a portion of a PIC illumination element 210 utilized in display devices and systems described herein, in accordance with some embodiments. As shown in FIG. 2, PIC illumination element 210 may include ridge waveguides 212 having a core and and cladding structure, as shown, e.g., in FIG. 1. Ridge waveguides 212 may be disposed on a base layer 218, such as a silicon, glass, or other suitable substrate. Out-coupling emitters, such as out-coupling gratings 214, may be formed in portions of ridge waveguides 212 so as to provide an array of out-coupling emitters in PIC illumination element 210.

In at least one example, out-coupling gratings 214 and/or other light scattering structures may be formed on cores (e.g., core 102 in FIG. 1) of ridge waveguides 212, with out-coupling gratings 214 extending through at least portion of the cladding layers (e.g., cladding 104 in FIG. 1). Out-coupling gratings 214 may scatter polarized light passing through ridge waveguides 212, redirecting emitted light 216 outward from ridge waveguides 212. Out-coupling gratings 214 may be configured to emit light in a controlled manner, with light from individual out-coupling gratings 214 having generally conical emission cones that intersect and at least partially overlap other emission cones emitted from the array of out-coupling gratings 214. Out-coupling gratings 214 may be any suitable light-scattering grating type, including, for example, short gratings, chirped gratings, resonant gratings, and/or any other suitable gratings and/or scattering structures.

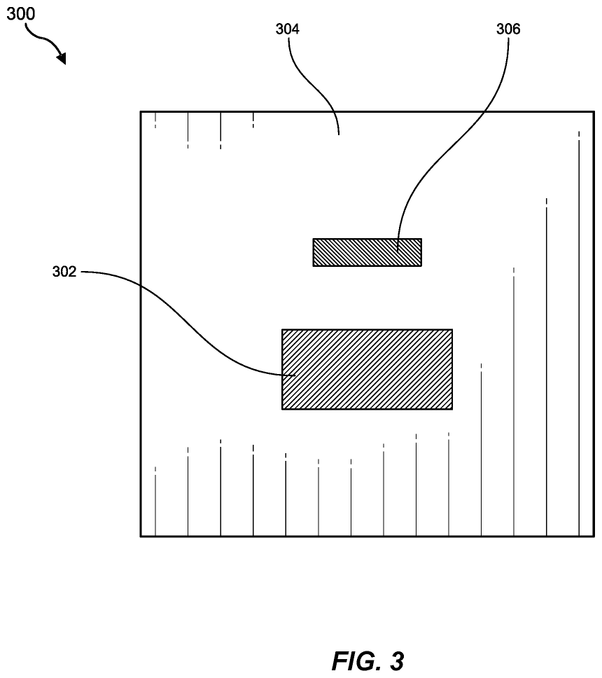

FIG. 3 illustrates a cross-sectional view of a waveguide 300 utilized in display devices and systems described herein, in accordance with some embodiments. In some embodiments, as shown in FIG. 3, an additional layer, such as a grating layer 306, may be deposited and/or grown either on top of or below a core layer 302 of waveguide 300. Grating layer 306 may include any suitable material, such as a dielectric material (e.g., aluminum oxide, etc.). Gratings and/or other scattering structures may be formed in grating layer 306. In this example, polarized light may propagate along core 302 of waveguide 300 and may be out-coupled when it interacts with a grating and/or other scattering structures formed in grating layer 306. A cladding 304, which may include one or more cladding layers, may at least partially surround core 302 and/or grating layer 306, as shown in FIG. 3.

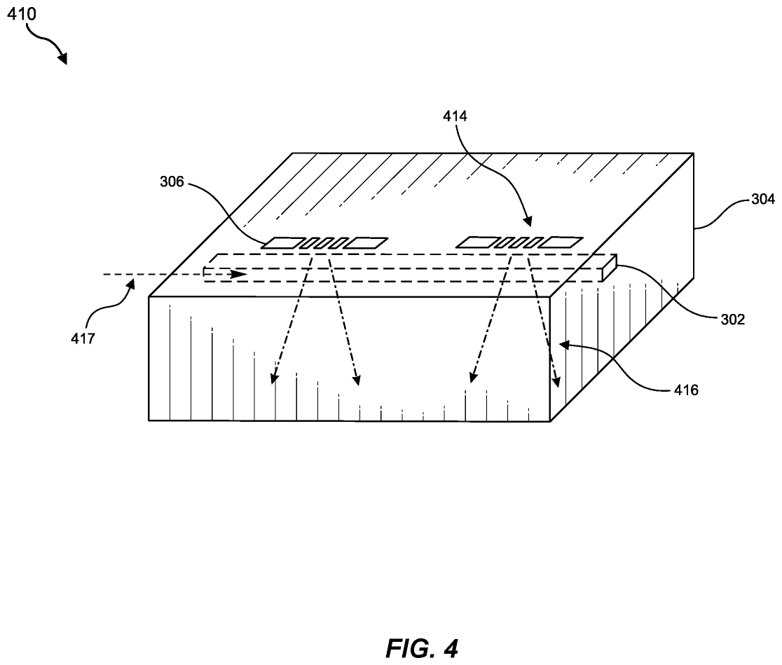

FIG. 4 illustrates a perspective view of a portion of a PIC illumination element 410 utilized in display devices and systems described herein, in accordance with some embodiments. As shown in FIG. 4, PIC illumination element 410 may include one or more cores 302 surrounded by cladding 304 and overlapped by corresponding grating layers 306. Grating layers 306 may be disposed on cladding 304 and/or within cladding 304 so as to be at least partially surrounded by cladding 304 (see, e.g., FIG. 3).

Out-coupling emitters, such as out-coupling gratings 414 shown in FIG. 4, may be formed in portions of grating layers 306 so as to provide an array of out-coupling emitters in PIC illumination element 410. Out-coupling gratings 414 may scatter polarized light passing through core 302 and/or portions of cladding 304, redirecting emitted light 416 outward. Out-coupling gratings 414 and/or other scattering structures formed in grating layers 306 may be configured to output emitted light 416 in a controlled manner such that output cone angles, directions, strengths, and/or any other suitable characteristics of emitted light 416 are tailored for selected applications. According to some examples, source light 417 input to core 302 may be polarized (e.g., linearly polarized).

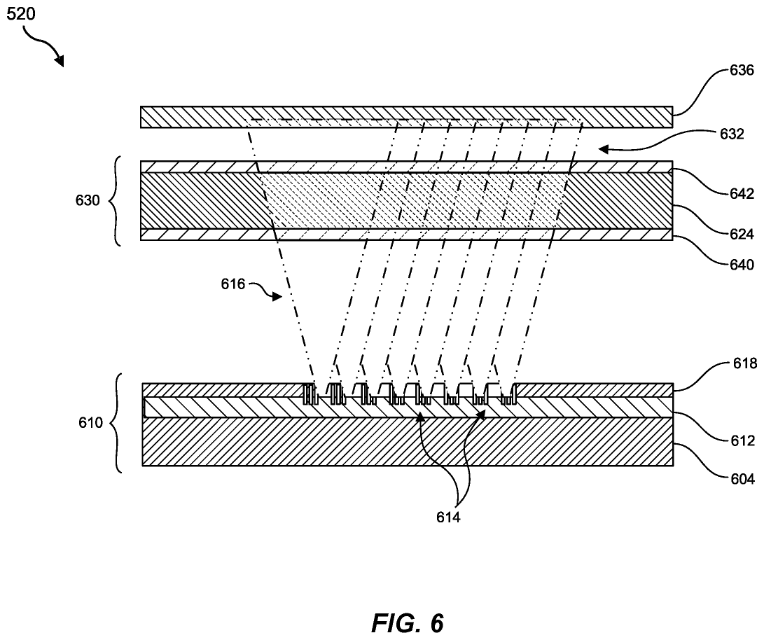

According to some embodiments, PIC illumination elements may be used to guide and extract laser light towards a display the LCD and/or LCoS display. A PIC illumination element can be either above the LC layer, as shown in FIG. 5, or below the LC layer, as shown in FIG. 6. For example, in reflective (front-lit) displays, the PIC may be above the LC layer (see FIG. 5), and in transmissive (backlit) displays, the PIC may be below the LC layer (see FIG. 6). PIC emitters of a PIC illumination element may either be aligned pixel-by-pixel or not aligned pixel-by-pixel (NAP) relative to pixels in a display panel. The PIC illumination systems described herein may emit light in such a manner that an NAP array of PIC emitters (e.g., out-coupling gratings 214 and/or 414 in FIGS. 2 and 4) may be utilized, facilitating compatibility and assembly of display systems without regard to the size and arrangement of display pixels. For example, each PIC emitter may illuminate a relatively large area on the display that contains a few to many LC pixels. In some examples, color sequential operation and/or color filters may be utilized for full color displays.

FIG. 5 illustrates a cross-sectional view of a reflective-type (front-lit) display system 520 that includes a PIC illumination element 510, in accordance with some embodiments. As shown in this figure, PIC illumination element 510 may overlap a reflective-type display element 530, such as an LCoS display element. PIC illumination element 510 may include a plurality of waveguides 512, each of which may include a plurality of out-coupling emitters 514 (e.g., out-coupling gratings 214 and/or 414 in FIGS. 2 and 4). Waveguides 512 may be disposed between transmissive layers 518 and 534 (e.g., glass layers, transparent dielectric layers, transparent polymer layers, etc.). The plurality of out-coupling emitters 514 of the plurality of waveguides 512 may form an array of out-coupling emitters 514 overlapping reflective-type display element 530 as shown, with the array of out-coupling emitters 514 being arranged in an NAP manner with an array of pixels of reflective-type display element 530.

Light from waveguides 512 may be out-coupled and scattered by out-coupling emitters 514 toward reflective-type display element 530 along emitted light 516 paths having cone angles that at least partially overlap in reflective-type display element 530. Emitted light 516 from PIC illumination element 510 may pass through a transparent layer 522, such as a cover glass layer, of reflective-type display element 530, and through a liquid crystal layer 524. An array of electrodes 527 in an active layer 526 abutting liquid crystal layer 524 may define pixel regions of liquid crystal layer 524, with the array of electrodes 527 selectively modulating transmission of light through pixel regions of liquid crystal layer 524. Active layer 526 may be disposed on a base layer 528, such as a silicon base layer.

Surfaces of electrodes 527, other portions of active layer 526, and/or base layer 528 may be reflective such that emitted light 516 passing through pixel regions of liquid crystal layer 524 is reflected back toward PIC illumination element 510 as pixelated light 532. Pixelated light 532 may pass through PIC illumination element 510, which includes a polarizer 536 that may be located at or near a light-output side of PIC illumination element 510. Out-coupling emitters 514 of waveguides 512 may be configured to minimally interfere with pixelated light 532 so as to have little or no effect on a pixelated image formed by pixelated light 532. Pixelated light 532 passing through polarizer 536 may be output from PIC illumination element 510 as polarized light 538, which may be directed toward other display optics (e.g., a projector) configured to present an image formed by polarized light 538 to a user.

FIG. 6 illustrates a cross-sectional view of a transmissive-type (backlit) display system 620 that includes a PIC illumination element 610, in accordance with some embodiments. As shown in this figure, PIC illumination element 610 may overlap a transmissive-type display element 630, such as a transmissive liquid crystal display element. PIC illumination element 610 may include a plurality of waveguides 612, each of which may include a plurality of out-coupling emitters 614 (e.g., out-coupling gratings 214 and/or 414 in FIGS. 2 and 4). Waveguides 612 may be disposed on a base layer 604 (e.g., a silicon layer) and may be covered by a transmissive layer 618 (e.g., a glass layer, transparent dielectric layer, transparent polymer layer, etc.). The plurality of out-coupling emitters 614 of the plurality of waveguides 612 may form an array of out-coupling emitters 614 overlapping transmissive-type display element 630 as shown, with the array of out-coupling emitters 614 being arranged in an NAP manner with an array of pixels of transmissive-type display element 630.

Light from waveguides 612 may be out-coupled and scattered by out-coupling emitters 614 toward transmissive-type display element 630 along emitted light 616 paths having cone angles that at least partially overlap in transmissive-type display element 630. Emitted light 616 from PIC illumination element 610 may pass through transmissive-type display element 630, which may include a liquid crystal layer 624 disposed between a pair of electrode layers 640 and 642 abutting liquid crystal layer 624. In some examples, one of electrode layers 640 and 642 include an array of driving electrodes and the other of electrode layers 640 and 642 may include a common electrode. Electrode layers 640 and 642 may define pixel regions of liquid crystal layer 624, with driving electrodes being selectively driven to modulate transmission of emitted light 616 through pixel regions of liquid crystal layer 624 so as to form an image.

Emitted light 616 passing through pixel regions of liquid crystal layer 624 may be output from transmissive-type display element 630 as pixelated light 632, which may then pass through polarizer 636 located at or near a light-output side of display system 620. Pixelated light 632 passing through polarizer 636 may be output as polarized light, which may be directed toward other display optics (e.g., a projector, viewing lens, screen, etc.) configured to present an image formed by polarized light 638 to a user.

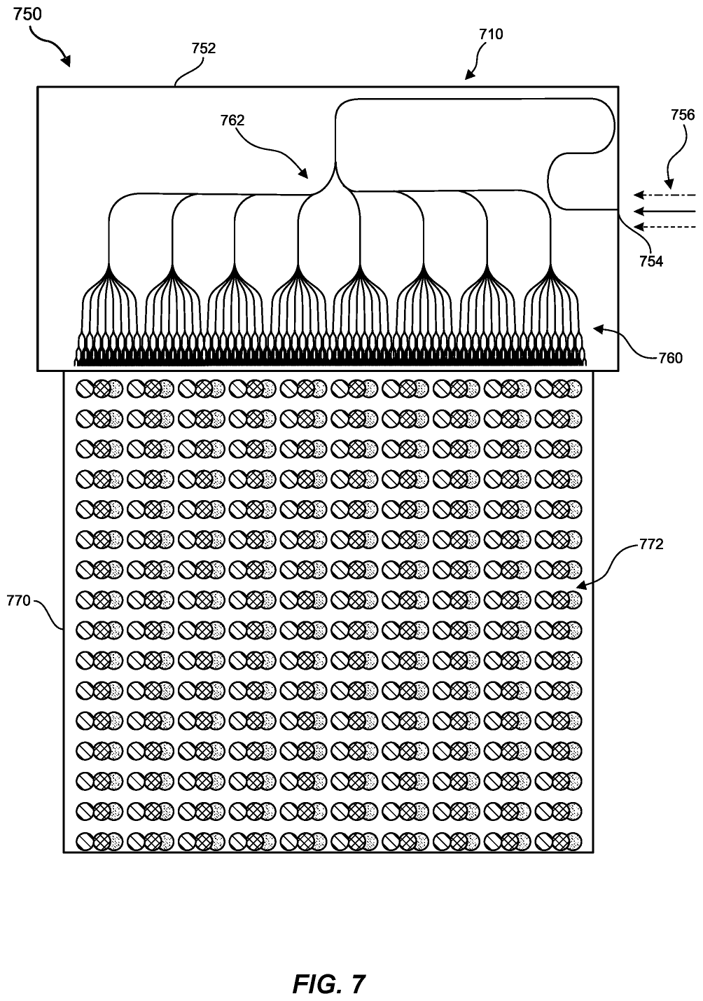

FIG. 7 shows an illustration of a display system 750 that includes a PIC illumination element 710 according to various embodiments. As shown, PIC illumination element 710 may include a source light in-coupler 754 that receives source light 756, such as polarized light, from one or more light sources (e.g., laser emitters). PIC illumination element 710 may include a dispatch circuit 752 that directs in-coupled light along one or more waveguide paths, which may split and or redirect light to a plurality of plurality of waveguides forming an array of out-coupling emitters, as described herein. As shown in FIG. 7, dispatch circuit 752 may include splitters 762, such as y-splitter trees, that divide and redirect light along multiple additional paths through dispatch circuit 752. Additionally, dispatch circuit 752 may include one or more sets of dispatch circuit subunits 760, which may include, for example, star couplers, evanescent couplers, waveguide crossings, and/or any other suitable elements.

In some examples, light (e.g., RGB light) can be guided in a single layer of a PIC illumination element 710 via a wavelength multiplexer and demultiplexer. Additionally or alternatively, RGB light can be guided in separated layers of PIC illumination element 710, where, for example, each layer guides one color of light. Laser diodes, or SLEDs (super luminescence LEDs) can be in-coupled to PIC illumination element 710 through various methods, such as edge coupling, flip-chip laser bonding, etc. In some examples, light with different colors can be pre-combined before being coupled with PIC illumination element 710 and/or combined through PIC devices via a separate PIC component.

As shown in FIG. 7, display system 750 may include a display element 770 that includes an array of pixels 772 disposed so as to overlap an array of out-coupling emitters coupled to dispatch circuit 752 via waveguides. As described herein, the out-coupling emitters can be either above a liquid crystal layer of display element 770 (see FIG. 5) or below the liquid crystal layer of display element 770 (see FIG. 6), corresponding to reflective (front-lit) and transmissive (backlit) modes respectively. For either type, the distance between the display pixel layer/liquid crystal layer of display element 770 and the illumination layer including the out-coupling emitters can be adjusted for various applications. For front-lit displays, illumination may pass through the illumination layer again upon reflection (e.g., reflection from the LCoS reflective surface regions). PIC illumination elements and display elements in front-lit display systems may be configured to avoid excessive interaction between the reflected light and grating/scattering layers of the PIC illumination elements (e.g., out-coupling gratings and/or other light scattering structures) so as to mitigate or suppress ghost images and/or other image distortions and/or artifacts.

FIG. 8 is a flow diagram of an exemplary method 800 for manufacturing a display system that includes a display element and a PIC illumination element in accordance with embodiments of this disclosure. As illustrated in FIG. 8, at step 810, at least one light source may be coupled to a PIC illumination element. The PIC illumination element may include at least one in-coupler for in-coupling light from the at least one light source and an array of out-coupling emitters configured to emit light from an output side of the PIC illumination element.

At step 820 in FIG. 8, a display element may be positioned over the output side of the PIC illumination element such that the array of out-coupling emitters is not aligned pixel-by-pixel with an array of pixels of the display element.

Display systems including PIC illumination elements, as disclosed herein, may provide various advantages in comparison to conventional systems. Advantages of the PIC illumination elements may include, for example, improvements in efficiency of the display light engine. More particularly, improvements may, for example, include the following.

Improvements in polarized output: the out-coupled light from PIC illuminators may be highly polarized and may eliminates the 50% light loss that commonly occurs with the first polarizer.

Directional emission: AR/VR display assemblies commonly suffer from significant light loss due to chief ray angle (CRA) and NA mismatch. With PIC illuminators, sufficient degrees of freedom may be available to engineerthe chief ray angle and emission cone, which may improve the collection efficiency.

Additionally, the narrow bandwidth of PIC may also open new possibilities for using diffractive collimation optics, which may further reduce the size/weight of displays as well as potentially new optical architectures.

The PIC illumination elements may also reduce the form factor of displays by 1) replacing conventional bulky illumination units in the case of (f)LCoS displays; and 2) simplifying display stacks (e.g., removing polarizers) in the case of LCDs.

Because the display systems including PIC illumination elements, as disclosed herein, can be coupled with a display in a not aligned pixel-by-pixel (NAP) relationship, they may provide additional advantages over conventional systems, including:

Easier alignment & integration. The alignment requirement between the PIC illumination element and the LC is greatly relaxed. The PIC illumination element can be fabricated as a stand-alone module and integrated with a pre-packaged LCD/LCoS later.

The PIC emitters can be sparsely placed regardless of the display pixel density. This may greatly simplify the PIC design and fabrication and allow for easy implementation of RGB circuits on a single layer.

The PIC emitter placement may be decoupled from the display pixel layout. This may allow the use of non-rectangular pixel layouts, such as pentile layouts. The PIC emitters are also not limited to a rectangular lattice. Quasi-random emitter placement can be used to enable engineered illumination profiles such as hyperuniform illumination.

Sparse emitter placement may also facilitate easier implementation of zonal illumination. In zonal illumination systems, PIC circuits may be divided into subregions that can be controlled independently, which is important for improving the illumination efficiency.

### [Inventor(S): Following Section is Boilerplate/Claims Restatement]

Embodiments of the present disclosure may include or be implemented in conjunction with various types of artificial-reality systems. Artificial reality is a form of reality that has been adjusted in some manner before presentation to a user, which may include, for example, a virtual reality, an augmented reality, a mixed reality, a hybrid reality, or some combination and/or derivative thereof. Artificial-reality content may include completely computer-generated content or computer-generated content combined with captured (e.g., real-world) content. The artificial-reality content may include video, audio, haptic feedback, or some combination thereof, any of which may be presented in a single channel or in multiple channels (such as stereo video that produces a three-dimensional (3D) effect to the viewer). Additionally, in some embodiments, artificial reality may also be associated with applications, products, accessories, services, or some combination thereof, that are used to, for example, create content in an artificial reality and/or are otherwise used in (e.g., to perform activities in) an artificial reality.

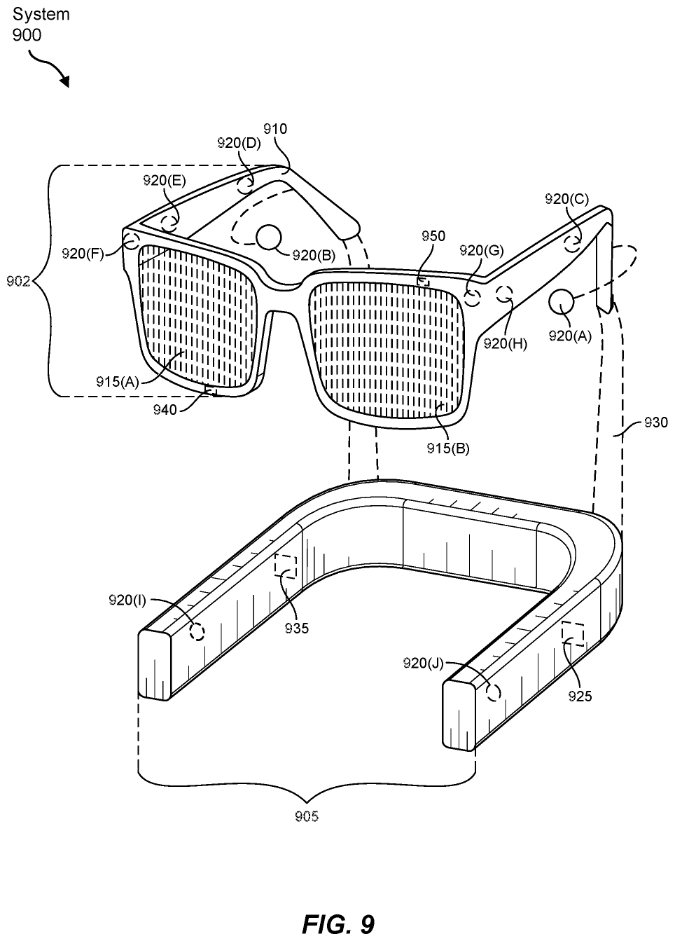

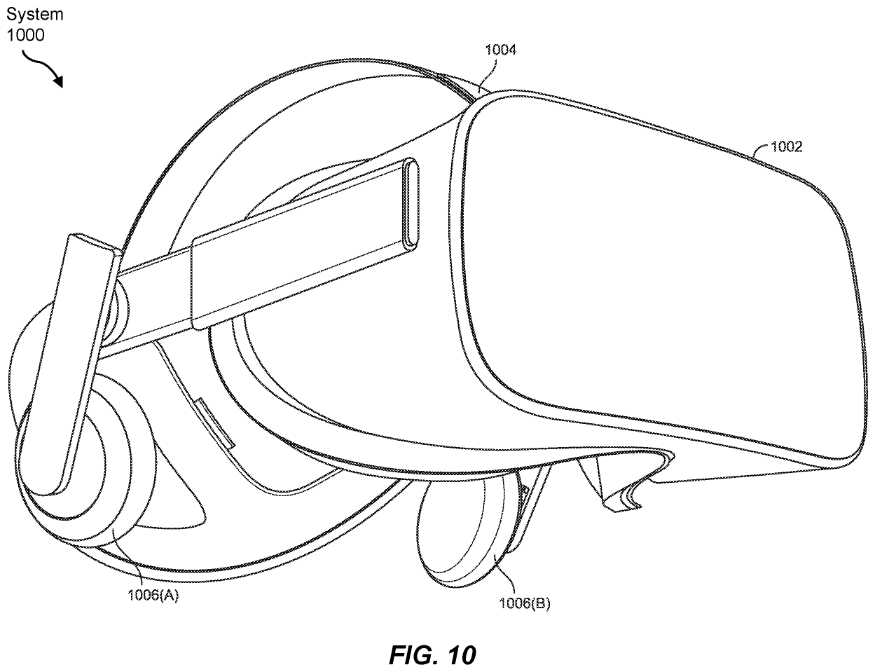

Artificial-reality systems may be implemented in a variety of different form factors and configurations. Some artificial-reality systems may be designed to work without near-eye displays (NEDs). Other artificial-reality systems may include an NED that also provides visibility into the real world (such as, e.g., augmented-reality system 900 in FIG. 9) or that visually immerses a user in an artificial reality (such as, e.g., virtual-reality system 1000 in FIG. 10). While some artificial-reality devices may be self-contained systems, other artificial-reality devices may communicate and/or coordinate with external devices to provide an artificial-reality experience to a user. Examples of such external devices include handheld controllers, mobile devices, desktop computers, devices worn by a user, devices worn by one or more other users, and/or any other suitable external system.

Turning to FIG. 9, augmented-reality system 900 may include an eyewear device 902 with a frame 910 configured to hold a left display device 915(A) and a right display device 915(B) in front of a user's eyes. Display devices 915(A) and 915(B) may act together or independently to present an image or series of images to a user. While augmented-reality system 900 includes two displays, embodiments of this disclosure may be implemented in augmented-reality systems with a single NED or more than two NEDs.

In some embodiments, augmented-reality system 900 may include one or more sensors, such as sensor 940. Sensor 940 may generate measurement signals in response to motion of augmented-reality system 900 and may be located on substantially any portion of frame 910. Sensor 940 may represent one or more of a variety of different sensing mechanisms, such as a position sensor, an inertial measurement unit (IMU), a depth camera assembly, a structured light emitter and/or detector, or any combination thereof. In some embodiments, augmented-reality system 900 may or may not include sensor 940 or may include more than one sensor. In embodiments in which sensor 940 includes an IMU, the IMU may generate calibration data based on measurement signals from sensor 940. Examples of sensor 940 may include, without limitation, accelerometers, gyroscopes, magnetometers, other suitable types of sensors that detect motion, sensors used for error correction of the IMU, or some combination thereof.

In some examples, augmented-reality system 900 may also include a microphone array with a plurality of acoustic transducers 920(A)-920(J), referred to collectively as acoustic transducers 920. Acoustic transducers 920 may represent transducers that detect air pressure variations induced by sound waves. Each acoustic transducer 920 may be configured to detect sound and convert the detected sound into an electronic format (e.g., an analog or digital format). The microphone array in FIG. 9 may include, for example, ten acoustic transducers: 920(A) and 920(B), which may be designed to be placed inside a corresponding ear of the user, acoustic transducers 920(C), 920(D), 920(E), 920(F), 920(G), and 920(H), which may be positioned at various locations on frame 910, and/or acoustic transducers 920(I) and 920(J), which may be positioned on a corresponding neckband 905.

In some embodiments, one or more of acoustic transducers 920(A)-(J) may be used as output transducers (e.g., speakers). For example, acoustic transducers 920(A) and/or 920(B) may be earbuds or any other suitable type of headphone or speaker.

The configuration of acoustic transducers 920 of the microphone array may vary. While augmented-reality system 900 is shown in FIG. 9 as having ten acoustic transducers 920, the number of acoustic transducers 920 may be greater or less than ten. In some embodiments, using higher numbers of acoustic transducers 920 may increase the amount of audio information collected and/or the sensitivity and accuracy of the audio information. In contrast, using a lower number of acoustic transducers 920 may decrease the computing power required by an associated controller 950 to process the collected audio information. In addition, the position of each acoustic transducer 920 of the microphone array may vary. For example, the position of an acoustic transducer 920 may include a defined position on the user, a defined coordinate on frame 910, an orientation associated with each acoustic transducer 920, or some combination thereof.

Acoustic transducers 920(A) and 920(B) may be positioned on different parts of the user's ear, such as behind the pinna, behind the tragus, and/or within the auricle or fossa. Or, there may be additional acoustic transducers 920 on or surrounding the ear in addition to acoustic transducers 920 inside the ear canal. Having an acoustic transducer 920 positioned next to an ear canal of a user may enable the microphone array to collect information on how sounds arrive at the ear canal. By positioning at least two of acoustic transducers 920 on either side of a user's head (e.g., as binaural microphones), augmented-reality device 900 may simulate binaural hearing and capture a 3D stereo sound field around about a user's head. In some embodiments, acoustic transducers 920(A) and 920(B) may be connected to augmented-reality system 900 via a wired connection 930, and in other embodiments acoustic transducers 920(A) and 920(B) may be connected to augmented-reality system 900 via a wireless connection (e.g., a BLUETOOTH connection). In still other embodiments, acoustic transducers 920(A) and 920(B) may not be used at all in conjunction with augmented-reality system 900.

Acoustic transducers 920 on frame 910 may be positioned in a variety of different ways, including along the length of the temples, across the bridge, above or below display devices 915(A) and 915(B), or some combination thereof. Acoustic transducers 920 may also be oriented such that the microphone array is able to detect sounds in a wide range of directions surrounding the user wearing the augmented-reality system 900. In some embodiments, an optimization process may be performed during manufacturing of augmented-reality system 900 to determine relative positioning of each acoustic transducer 920 in the microphone array.

In some examples, augmented-reality system 900 may include or be connected to an external device (e.g., a paired device), such as neckband 905. Neckband 905 generally represents any type or form of paired device. Thus, the following discussion of neckband 905 may also apply to various other paired devices, such as charging cases, smart watches, smart phones, wrist bands, other wearable devices, hand-held controllers, tablet computers, laptop computers, other external compute devices, etc.

As shown, neckband 905 may be coupled to eyewear device 902 via one or more connectors. The connectors may be wired or wireless and may include electrical and/or non-electrical (e.g., structural) components. In some cases, eyewear device 902 and neckband 905 may operate independently without any wired or wireless connection between them. While FIG. 9 illustrates the components of eyewear device 902 and neckband 905 in example locations on eyewear device 902 and neckband 905, the components may be located elsewhere and/or distributed differently on eyewear device 902 and/or neckband 905. In some embodiments, the components of eyewear device 902 and neckband 905 may be located on one or more additional peripheral devices paired with eyewear device 902, neckband 905, or some combination thereof.

Pairing external devices, such as neckband 905, with augmented-reality eyewear devices may enable the eyewear devices to achieve the form factor of a pair of glasses while still providing sufficient battery and computation power for expanded capabilities. Some or all of the battery power, computational resources, and/or additional features of augmented-reality system 900 may be provided by a paired device or shared between a paired device and an eyewear device, thus reducing the weight, heat profile, and form factor of the eyewear device overall while still retaining desired functionality. For example, neckband 905 may allow components that would otherwise be included on an eyewear device to be included in neckband 905 since users may tolerate a heavier weight load on their shoulders than they would tolerate on their heads. Neckband 905 may also have a larger surface area over which to diffuse and disperse heat to the ambient environment. Thus, neckband 905 may allow for greater battery and computation capacity than might otherwise have been possible on a stand-alone eyewear device. Since weight carried in neckband 905 may be less invasive to a user than weight carried in eyewear device 902, a user may tolerate wearing a lighter eyewear device and carrying or wearing the paired device for greater lengths of time than a user would tolerate wearing a heavy standalone eyewear device, thereby enabling users to more fully incorporate artificial-reality environments into their day-to-day activities.

Neckband 905 may be communicatively coupled with eyewear device 902 and/or to other devices. These other devices may provide certain functions (e.g., tracking, localizing, depth mapping, processing, storage, etc.) to augmented-reality system 900. In the embodiment of FIG. 9, neckband 905 may include two acoustic transducers (e.g., 920(I) and 920(J)) that are part of the microphone array (or potentially form their own microphone subarray). Neckband 905 may also include a controller 925 and a power source 935.

Acoustic transducers 920(I) and 920(J) of neckband 905 may be configured to detect sound and convert the detected sound into an electronic format (analog or digital). In the embodiment of FIG. 9, acoustic transducers 920(I) and 920(J) may be positioned on neckband 905, thereby increasing the distance between the neckband acoustic transducers 920(I) and 920(J) and other acoustic transducers 920 positioned on eyewear device 902. In some cases, increasing the distance between acoustic transducers 920 of the microphone array may improve the accuracy of beamforming performed via the microphone array. For example, if a sound is detected by acoustic transducers 920(C) and 920(D) and the distance between acoustic transducers 920(C) and 920(D) is greater than, e.g., the distance between acoustic transducers 920(D) and 920(E), the determined source location of the detected sound may be more accurate than if the sound had been detected by acoustic transducers 920(D) and 920(E).

Controller 925 of neckband 905 may process information generated by the sensors on neckband 905 and/or augmented-reality system 900. For example, controller 925 may process information from the microphone array that describes sounds detected by the microphone array. For each detected sound, controller 925 may perform a direction-of-arrival (DOA) estimation to estimate a direction from which the detected sound arrived at the microphone array. As the microphone array detects sounds, controller 925 may populate an audio data set with the information. In embodiments in which augmented-reality system 900 includes an inertial measurement unit, controller 925 may compute all inertial and spatial calculations from the IMU located on eyewear device 902. A connector may convey information between augmented-reality system 900 and neckband 905 and between augmented-reality system 900 and controller 925. The information may be in the form of optical data, electrical data, wireless data, or any other transmittable data form. Moving the processing of information generated by augmented-reality system 900 to neckband 905 may reduce weight and heat in eyewear device 902, making it more comfortable to the user.

Power source 935 in neckband 905 may provide power to eyewear device 902 and/or to neckband 905. Power source 935 may include, without limitation, lithium ion batteries, lithium-polymer batteries, primary lithium batteries, alkaline batteries, or any other form of power storage. In some cases, power source 935 may be a wired power source. Including power source 935 on neckband 905 instead of on eyewear device 902 may help better distribute the weight and heat generated by power source 935.

As noted, some artificial-reality systems may, instead of blending an artificial reality with actual reality, substantially replace one or more of a user's sensory perceptions of the real world with a virtual experience. One example of this type of system is a head-worn display system, such as virtual-reality system 1000 in FIG. 10, that mostly or completely covers a user's field of view. Virtual-reality system 1000 may include a front rigid body 1002 and a band 1004 shaped to fit around a user's head. Virtual-reality system 1000 may also include output audio transducers 1006(A) and 1006(B). Furthermore, while not shown in FIG. 10, front rigid body 1002 may include one or more electronic elements, including one or more electronic displays, one or more inertial measurement units (IMUs), one or more tracking emitters or detectors, and/or any other suitable device or system for creating an artificial-reality experience.

Artificial-reality systems may include a variety of types of visual feedback mechanisms. For example, display devices in augmented-reality system 900 and/or virtual-reality system 1000 may include one or more liquid crystal displays (LCDs), light emitting diode (LED) displays, microLED displays, organic LED (OLED) displays, digital light project (DLP) micro-displays, liquid crystal on silicon (LCoS) micro-displays, and/or any other suitable type of display screen. These artificial-reality systems may include a single display screen for both eyes or may provide a display screen for each eye, which may allow for additional flexibility for varifocal adjustments or for correcting a user's refractive error. Some of these artificial-reality systems may also include optical subsystems having one or more lenses (e.g., concave or convex lenses, Fresnel lenses, adjustable liquid lenses, etc.) through which a user may view a display screen. These optical subsystems may serve a variety of purposes, including to collimate (e.g., make an object appear at a greater distance than its physical distance), to magnify (e.g., make an object appear larger than its actual size), and/or to relay (to, e.g., the viewer's eyes) light. These optical subsystems may be used in a non-pupil-forming architecture (such as a single lens configuration that directly collimates light but results in so-called pincushion distortion) and/or a pupil-forming architecture (such as a multi-lens configuration that produces so-called barrel distortion to nullify pincushion distortion).

In addition to or instead of using display screens, some of the artificial-reality systems described herein may include one or more projection systems. For example, display devices in augmented-reality system 900 and/or virtual-reality system 1000 may include micro-LED projectors that project light (using, e.g., a waveguide) into display devices, such as clear combiner lenses that allow ambient light to pass through. The display devices may refract the projected light toward a user's pupil and may enable a user to simultaneously view both artificial-reality content and the real world. The display devices may accomplish this using any of a variety of different optical components, including waveguide components (e.g., holographic, planar, diffractive, polarized, and/or reflective waveguide elements), light-manipulation surfaces and elements (such as diffractive, reflective, and refractive elements and gratings), coupling elements, etc. Artificial-reality systems may also be configured with any other suitable type or form of image projection system, such as retinal projectors used in virtual retina displays.

The artificial-reality systems described herein may also include various types of computer vision components and subsystems. For example, augmented-reality system 900 and/or virtual-reality system 1000 may include one or more optical sensors, such as two-dimensional (2D) or 3D cameras, structured light transmitters and detectors, time-of-flight depth sensors, single-beam or sweeping laser rangefinders, 3D LiDAR sensors, and/or any other suitable type or form of optical sensor. An artificial-reality system may process data from one or more of these sensors to identify a location of a user, to map the real world, to provide a user with context about real-world surroundings, and/or to perform a variety of other functions.

The artificial-reality systems described herein may also include one or more input and/or output audio transducers. Output audio transducers may include voice coil speakers, ribbon speakers, electrostatic speakers, piezoelectric speakers, bone conduction transducers, cartilage conduction transducers, tragus-vibration transducers, and/or any other suitable type or form of audio transducer. Similarly, input audio transducers may include condenser microphones, dynamic microphones, ribbon microphones, and/or any other type or form of input transducer. In some embodiments, a single transducer may be used for both audio input and audio output.

In some embodiments, the artificial-reality systems described herein may also include tactile (i.e., haptic) feedback systems, which may be incorporated into headwear, gloves, body suits, handheld controllers, environmental devices (e.g., chairs, floormats, etc.), and/or any other type of device or system. Haptic feedback systems may provide various types of cutaneous feedback, including vibration, force, traction, texture, and/or temperature. Haptic feedback systems may also provide various types of kinesthetic feedback, such as motion and compliance. Haptic feedback may be implemented using motors, piezoelectric actuators, fluidic systems, and/or a variety of other types of feedback mechanisms. Haptic feedback systems may be implemented independent of other artificial-reality devices, within other artificial-reality devices, and/or in conjunction with other artificial-reality devices.

By providing haptic sensations, audible content, and/or visual content, artificial-reality systems may create an entire virtual experience or enhance a user's real-world experience in a variety of contexts and environments. For instance, artificial-reality systems may assist or extend a user's perception, memory, or cognition within a particular environment. Some systems may enhance a user's interactions with other people in the real world or may enable more immersive interactions with other people in a virtual world. Artificial-reality systems may also be used for educational purposes (e.g., for teaching or training in schools, hospitals, government organizations, military organizations, business enterprises, etc.), entertainment purposes (e.g., for playing video games, listening to music, watching video content, etc.), and/or for accessibility purposes (e.g., as hearing aids, visual aids, etc.). The embodiments disclosed herein may enable or enhance a user's artificial-reality experience in one or more of these contexts and environments and/or in other contexts and environments.

The following example embodiments are also included in the present disclosure:

Example 1: A display system, including: a display element including an array of pixels; at least one light source; and a photonic integrated circuit (PIC) illumination element overlapping the display element. The PIC illumination element includes: at least one in-coupler for in-coupling light from the at least one light source; and an array of out-coupling emitters configured to emit light from the PIC illumination element toward the display element, wherein the array of out-coupling emitters is not aligned pixel-by-pixel with the array of pixels.

Example 2: The display system of Example 1, wherein the display element includes a reflective-type display element.

Example 3: The display system of Example 1, wherein the display element includes a transmissive-type display element.

Example 4: The display system of any one of Examples 1 through 3, wherein the PIC illumination element further includes a dispatch circuit configured to direct light from the in-coupler to the array of out-coupling emitters.

Example 5: The display system of Example 4, wherein the dispatch circuit includes at least one of a y-splitter tree, a star coupler, an evanescent coupler, or a waveguide crossing.

Example 6: The display system of any one of Examples 1 through 5, wherein the out-coupling emitters include at least one of a short grating, a chirped grating, or a resonant grating.

Example 7: The display system of any one of Examples 1 through 6, wherein light from multiple color light sources is guided through the PIC illumination element in a single PIC layer via a wavelength multiplexer and demultiplexer.

Example 8: The display system of any one of Examples 1 through 6, wherein light from multiple color light sources is guided through the PIC illumination element in separated PIC layers, wherein each of the separated PIC layers guides one of the multiple colors of light.

Example 9: The display system of any one of Examples 1 through 8, wherein the at least one light source includes at least one of a laser diode or a super luminescence light-emitting diode.

Example 10: The display system of any one of Examples 1 through 9, wherein the at least one light source is in-coupled to the at least one in-coupler by at least one of edge coupling or flip-chip laser bonding.

Example 11: The display system of any one of Examples 1 through 10, wherein different colors of light from the at least one light source are pre-combined before in-coupling with the PIC illumination element.

Example 12: The display system of any one of Examples 1 through 10, wherein different colors of light are combined through one or more separate PIC components within the PIC illumination element.

Example 13: The display system of any one of Examples 1 through 12, wherein the PIC illumination element includes at least one waveguide including: a core that is transparent to one or more wavelengths of light and has a first refractive index; and a cladding surrounding the core, the cladding having a second refractive index that is different than the first refractive index.

Example 14: The display system of Example 13, wherein at least some of the out-coupling emitters include at least one grating structure defined by a surface region of the core.

Example 15: The display system of Example 13 or Example 14, wherein at least some of the out-coupling emitters include at least one grating structure formed by a grating layer overlapping a portion of the core.

Example 16: The display system of Example 15, wherein the cladding at least partially surrounds the grating layer.

Example 17: The display system of any one of Examples 13 through 16, wherein the at least one waveguide includes a single mode waveguide or a multiple mode waveguide.

Example 18: The display system of Example 17, wherein the at least one waveguide utilizes at least one of a transverse electric mode or a transverse magnetic mode for light polarization.

Example 19: A display lighting unit, including: at least one light source; and a PIC illumination element overlapping the display element, the PIC illumination element including: at least one in-coupler for in-coupling light from the at least one light source; and an array of out-coupling emitters configured to emit light from the PIC illumination element such that light cones emitted from two or more of the out-coupling emitters at least partially overlap.

Example 20: A method including: coupling at least one light source to a PIC illumination element that includes: at least one in-coupler for in-coupling light from the at least one light source; and an array of out-coupling emitters configured to emit light from an output side of the PIC illumination element. The method further includes positioning a display element over the output side of the PIC illumination element such that the array of out-coupling emitters is not aligned pixel-by-pixel with an array of pixels of the display element.

The process parameters and sequence of the steps described and/or illustrated herein are given by way of example only and can be varied as desired. For example, while the steps illustrated and/or described herein may be shown or discussed in a particular order, these steps do not necessarily need to be performed in the order illustrated or discussed. The various example methods described and/or illustrated herein may also omit one or more of the steps described or illustrated herein or include additional steps in addition to those disclosed.

The preceding description has been provided to enable others skilled in the art to best utilize various aspects of the example embodiments disclosed herein. This example description is not intended to be exhaustive or to be limited to any precise form disclosed. Many modifications and variations are possible without departing from the spirit and scope of the present disclosure. The embodiments disclosed herein should be considered in all respects illustrative and not restrictive. Reference should be made to any claims appended hereto and their equivalents in determining the scope of the present disclosure.

Unless otherwise noted, the terms “connected to” and “coupled to” (and their derivatives), as used in the specification and/or claims, are to be construed as permitting both direct and indirect (i.e., via other elements or components) connection. In addition, the terms “a” or “an,” as used in the specification and/or claims, are to be construed as meaning “at least one of.” Finally, for ease of use, the terms “including” and “having” (and their derivatives), as used in the specification and/or claims, are interchangeable with and have the same meaning as the word “comprising.”

What is claimed is:

1. A display system, comprising:
a display element comprising an array of pixels;
at least one light source; and
a photonic integrated circuit (PIC) illumination element overlapping the display element, the PIC illumination element comprising:
at least one in-coupler for in-coupling light from the at least one light source; and
an array of out-coupling emitters configured to emit light from the PIC illumination element toward the display element, wherein the array of out-coupling emitters is not aligned pixel-by-pixel with the array of pixels.

2. The display system of claim 1, wherein the display element comprises a reflective-type display element.

3. The display system of claim 1, wherein the display element comprises a transmissive-type display element.

4. The display system of claim 1, wherein the PIC illumination element further comprises a dispatch circuit configured to direct light from the in-coupler to the array of out-coupling emitters.

5. The display system of claim 4, wherein the dispatch circuit comprises at least one of a y-splitter tree, a star coupler, an evanescent coupler, or a waveguide crossing.

6. The display system of claim 1, wherein the out-coupling emitters comprise at least one of a short grating, a chirped grating, or a resonant grating.

7. The display system of claim 1, wherein light from multiple color light sources is guided through the PIC illumination element in a single PIC layer via a wavelength multiplexer and demultiplexer.

8. The display system of claim 1, wherein light from multiple color light sources is guided through the PIC illumination element in separated PIC layers, wherein each of the separated PIC layers guides one of the multiple colors of light.

9. The display system of claim 1, wherein the at least one light source comprises at least one of a laser diode or a super luminescence light-emitting diode.

10. The display system of claim 1, wherein the at least one light source is in-coupled to the at least one in-coupler by at least one of edge coupling or flip-chip laser bonding.

11. The display system of claim 1, wherein different colors of light are pre-combined before in-coupling with the PIC illumination element.

12. The display system of claim 1, wherein different colors of light are combined through one or more separate PIC components within the PIC illumination element.

13. The display system of claim 1, wherein the PIC illumination element comprises at least one waveguide comprising:
a core that is transparent to one or more wavelengths of light and has a first refractive index; and
a cladding surrounding the core, the cladding having a second refractive index that is different than the first refractive index.

14. The display system of claim 13, wherein at least some of the out-coupling emitters comprise at least one grating structure defined by a surface region of the core.

15. The display system of claim 13, wherein at least some of the out-coupling emitters comprise at least one grating structure formed by a grating layer overlapping a portion of the core.

16. The display system of claim 15, wherein the cladding at least partially surrounds the grating layer.

17. The display system of claim 13, wherein the at least one waveguide comprises a single mode waveguide or a multiple mode waveguide.

18. The display system of claim 17, wherein the at least one waveguide utilizes at least one of a transverse electric mode or a transverse magnetic mode for light polarization.

19. A display lighting unit, comprising:
at least one light source; and
a PIC illumination element overlapping the display element, the PIC illumination element comprising:
at least one in-coupler for in-coupling light from the at least one light source; and
an array of out-coupling emitters configured to emit light from the PIC illumination element such that light cones emitted from two or more of the out-coupling emitters at least partially overlap.

20. A method comprising:
coupling at least one light source to a PIC illumination element that comprises:
at least one in-coupler for in-coupling light from the at least one light source; and
an array of out-coupling emitters configured to emit light from an output side of the PIC illumination element; and
positioning a display element over the output side of the PIC illumination element such that the array of out-coupling emitters is not aligned pixel-by-pixel with an array of pixels of the display element.
